(19) United States
(12) Patent Application Publication
(10) Pub. No.: US 2024/0256466 A1
(43) Pub. Date: Aug. 1, 2024

(54) MEMORY CONTROLLER AND FLASH MEMORY SYSTEM

(71) Applicant: TDK CORPORATION, Tokyo (JP)

(72) Inventor: Kenichi TAKUBO, Tokyo (JP)

(73) Assignee: TDK CORPORATION, Tokyo (JP)

(21) Appl. No.: 18/019,329

(22) PCT Filed: Nov. 10, 2021
(86) PCT No.: PCT/JP2021/041368

§ 371 Date: Feb. 2, 2023

(51) Int. Cl. G06F 12/14

(52) U.S. Cl. CPC G06F 12/1408; G06F 12/1466

(57) ABSTRACT

A memory controller controls a flash memory. The memory controller includes an arithmetic processor that performs control on data in a user data region of the flash memory. The arithmetic processor performs a first encryption process on data included in a first region, using a first cryptographic key that is fixed, and stores first encrypted data resulting from the first encryption process in the user data region. The arithmetic processor performs a second encryption process on data included in a second region, using a second cryptographic key that is newly generated upon each power-on transition during which power to the flash memory and the memory controller transitions from an OFF state to an ON state, and stores second encrypted data resulting from the second encryption process in the user data region.

### TECHNICAL FIELD

The disclosure relates to a memory controller and a flash memory system.

### BACKGROUND ART

A memory controller that controls a nonvolatile memory such as a flash memory, and a memory system including such a memory controller and the nonvolatile memory, such as a flash memory system, have been proposed (see Patent Literature 1, for example).

### CITATION LIST

### Patent Literature

Patent Literature 1: Japanese Unexamined Patent Application Publication (Published Japanese Translation of PCT Application) No. JP2021-520021

### SUMMARY

A memory controller according to an embodiment of the disclosure is a memory controller controlling a flash memory. The memory controller includes an arithmetic processor that performs control on data in a user data region of the flash memory. The arithmetic processor performs a first encryption process on data included in a first region, using a first cryptographic key that is fixed, and stores first encrypted data resulting from the first encryption process in the user data region. The arithmetic processor performs a second encryption process on data included in a second region, using a second cryptographic key that is newly generated upon each power-on transition during which power to the flash memory and the memory controller transitions from an OFF state to an ON state, and stores second encrypted data resulting from the second encryption process in the user data region.

A flash memory system according to an embodiment of the disclosure includes the memory controller according to the foregoing embodiment of the disclosure, and the flash memory.

### BRIEF DESCRIPTION OF THE DRAWINGS

FIG. 1 is a block diagram illustrating a schematic configuration example of systems including a flash memory system according to one example embodiment of the disclosure.

FIG. 2A is a block diagram illustrating a detailed configuration example of an arithmetic processor illustrated in FIG. 1.

FIG. 2B is a block diagram illustrating another detailed configuration example of the arithmetic processor illustrated in FIG. 1.

FIG. 3 is a flowchart illustrating an example of activation processing according to the example embodiment.

### DETAILED DESCRIPTION

It is typically desired that a memory controller and a memory system such as a flash memory system achieve improved security with a simple configuration. It is desirable to provide a memory controller and a flash memory system that each make it possible to improve security with a simple configuration.

A description is given in detail below of some example embodiments of the disclosure with reference to the drawings. The description is given in the following order.
1. Example Embodiment (an example of using a cryptographic key that is newly generated each time for data in a secure region)
2. Modification Examples

### 1. Example Embodiment

### Configuration

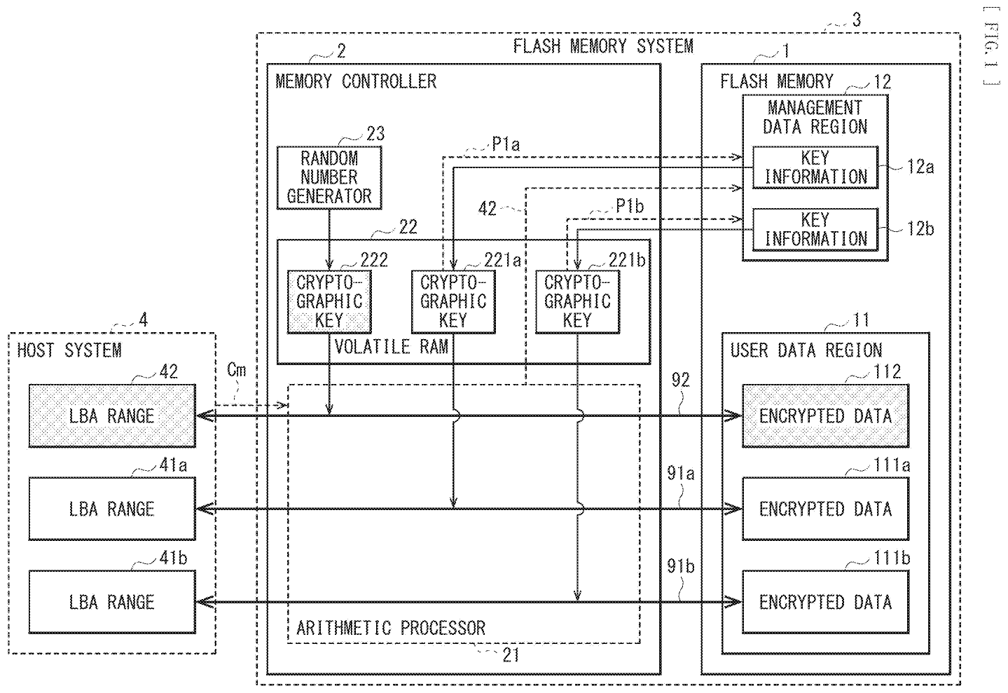

FIG. 1 illustrates a schematic configuration example of a flash memory system (a flash memory system 3) according to an example embodiment of the disclosure, together with an external host system 4, in a block diagram. The flash memory system 3 is a system corresponding to, for example, a solid state drive (SSD), an embedded multimedia card (eMMC), or the like.

As illustrated in FIG. 1, the flash memory system 3 includes a flash memory 1 and a memory controller 2. The host system 4, the memory controller 2, and the flash memory 1 are coupled to each other via various buses 91a, 91b, and 92, as illustrated in FIG. 1.

### (A. Host System 4)

The host system 4 is a host system that uses the flash memory system 3 as a secondary storage device. The host system 4 includes a central processing unit (CPU), a companion chip, and other components. The CPU controls operation of the entire host system 4. The companion chip transmits and receives various pieces of data to and from the flash memory system 3. Such a host system 4 is, for example, an information processor such as a personal computer (PC) or a digital still camera.

Further, as illustrated in FIG. 1, for example, the host system 4 supplies a predetermined command Cm (an internal command) to the flash memory system 3 to thereby instruct the flash memory system 3 to execute various kinds of processing. Specifically, the command Cm is a command for the memory controller 2 in the flash memory system 3 to instruct the flash memory 1 to execute various kinds of processing. Thus, the flash memory 1 performs various kinds of operations in accordance with the command Cm supplied from the memory controller 2.

### (B. Flash Memory 1)

The flash memory 1 is a nonvolatile memory, and includes one or more flash memory chips (chips). For example, the flash memory 1 is a NAND flash memory. With the NAND flash memory, data is written and read on a page-by-page basis, and data is erased (batch-erased) on a block-by-block basis. Each block includes multiple pages.

In this connection, the page and the block of the flash memory 1 are typically also referred to as a physical page and a physical block, respectively. This is for distinction from a logical page and a logical block which are units to be used by the host system 4 in handling data.

Specifically, each physical block includes, for example, 64, 128, or 256 physical pages. Further, each physical page includes, for example, 4, 8, or 16 sectors (physical sectors). Each physical sector is a region allocated to store data of 512 bytes (data of one sector).

The flash memory 1 includes a register, and a memory cell array in which multiple memory cells are aligned. The memory cell array includes multiple memory cell groups and a word line. Each of the memory cell groups includes multiple ones of the memory cells coupled in series. The word line is provided to select a particular one of the memory cells from the memory cell group. Writing of data from the register into the selected memory cell, or reading of data from the selected memory cell to the register is performed between the selected memory cell and the register via the word line.

Further, as illustrated in FIG. 1, the flash memory 1 includes a user data region 11 and a management data region 12. The user data region 11 is a region where user data is stored.

### (User Data Region 11)

In the example illustrated in FIG. 1, encrypted data 111a, 111b, and 112 are each stored in the user data region 11.

Each of the encrypted data 111a and 111b is data (user data) included in a normal region, and the encrypted data 112 is data (user data) included in a secure region. The normal region refers to a logical block address (LBA) range that is set to require no discarding of data when power to the flash memory system 3 including the flash memory 1 and the memory controller 2 transitions from an ON state to an OFF state, that is, upon a power-off transition. In contrast, the secure region refers to an LBA range that is set to require discarding of data upon the power-off transition.

Examples of the user data to be stored in the secure region (the region requiring discarding of data upon the power-off transition) include various kinds of data to be secured, including passwords, financial information, medical information, data under arithmetic operation, and data under copying.

Setting of the normal region and the secure region, that is, setting of whether or not it is necessary to discard data upon the power-off transition, is performed in advance on the host system 4 side by the command Cm described above, for example. Specifically, in the example illustrated in FIG. 1, LBA ranges 41a and 41b set on the host system 4 side define respective regions (normal regions) where cryptographic keys 221a and 221b to be described later are applied. Further, an LBA range 42 set on the host system 4 side defines a region (secure region) where a cryptographic key 222 to be described later is applied.

The regions defined by the LBA ranges 41a and 41b, i.e., the normal regions, each correspond to a specific example of a “first region” in one embodiment of the disclosure. Similarly, the region defined by the LBA range 42, i.e., the secure region, corresponds to a specific example of a “second region” in one embodiment of the disclosure. The encrypted data 111a and 111b each correspond to “first encrypted data” in one embodiment of the disclosure. Similarly, the encrypted data 112 corresponds to “second encrypted data” in one embodiment of the disclosure.

### (Management Data Region 12)

The management data region 12 is a region where various kinds of management data are stored. In the example illustrated in FIG. 1, pieces of information (pieces of key information 12a and 12b) underlying the cryptographic keys 221a and 221b to be described later are each stored in the management data region 12. The settings of the LBA ranges described above are also stored in the management data region 12.

### (C. Memory Controller 2)

The memory controller 2 controls the flash memory 1 in accordance with a command from the host system 4, that is, the command Cm described above. Specifically, for example, upon receiving a write request from the host system 4, the memory controller 2 writes data (user data) received from the host system 4 into the flash memory 1. Further, for example, upon receiving a read request from the host system 4, the memory controller 2 reads data (user data) from the flash memory 1 and transmits the data to the host system 4.

Such a memory controller 2 includes components including, without limitation, a microprocessor, a host interface block, a static random access memory (SRAM), a buffer, a flash memory interface block, and a read-only memory (ROM).

Specifically, in the example illustrated in FIG. 1, the memory controller 2 includes an arithmetic processor 21, a volatile RAM 22, and a random number generator 23 each including the microprocessor, etc. described above.

### (Volatile RAM 22 and Random Number Generator 23)

The volatile RAM 22 is a volatile memory such as the SRAM describe above, for example. In the example illustrated in FIG. 1, the cryptographic keys 221a, 221b, and 222 are each stored in the volatile RAM 22.

The cryptographic keys 221a and 221b are cryptographic keys applied to the encrypted data 111a and 111b, respectively, as illustrated in FIG. 1. Specifically, the encrypted data 111a and 111b are each generated by subjecting respective data included in the LBA ranges 41a and 41b (the normal regions) to encryption processes using the cryptographic keys 221a and 221b, respectively. The encrypted data 111a and 111b thus generated are stored in the user data region 11 in the flash memory 1.

The cryptographic keys 221a and 221b are generated respectively on the basis of the pieces of key information 12a and 12b stored in the management data region 12, as illustrated in FIG. 1. Further, each of these cryptographic keys 221a and 221b is a cryptographic key that includes fixed (invariable) information. The cryptographic keys 221a and 221b generated in this way are each finally stored in the management data region 12 in the flash memory 1, as indicated by broken-line arrows P1a and P1b in FIG. 1, for example.

The cryptographic key 222 is a cryptographic key applied to the encrypted data 112. Specifically, the encrypted data 112 is generated by subjecting data included in the LBA range 42 (the secure region) to an encryption process using the cryptographic key 222. The encrypted data 112 thus generated is stored in the user data region 11 in the flash memory 1.

The cryptographic key 222 is generated on the basis of random numbers obtained from the random number generator 23, as illustrated in FIG. 1, unlike the cryptographic keys 221a and 221b described above. Specifically, the cryptographic key 222 is newly generated on the basis of such random numbers each time the power to the flash memory system 3 including the flash memory 1 and the memory controller 2 transitions from the OFF state to the ON state, that is, upon each power-on transition (power activation). Thus, the cryptographic key 222 is a cryptographic key that includes variable information, unlike the cryptographic keys 221a and 221b described above.

The cryptographic keys 221a and 221b each correspond to a specific example of a “first cryptographic key” in one embodiment of the disclosure. The cryptographic key 222 corresponds to a specific example of a “second cryptographic key” in one embodiment of the disclosure.

(Arithmetic processor 21)

The arithmetic processor 21 performs various kinds of control on data (user data) in the user data region 11 of the flash memory 1. The arithmetic processor 21 includes the microprocessor, etc. described above, for example.

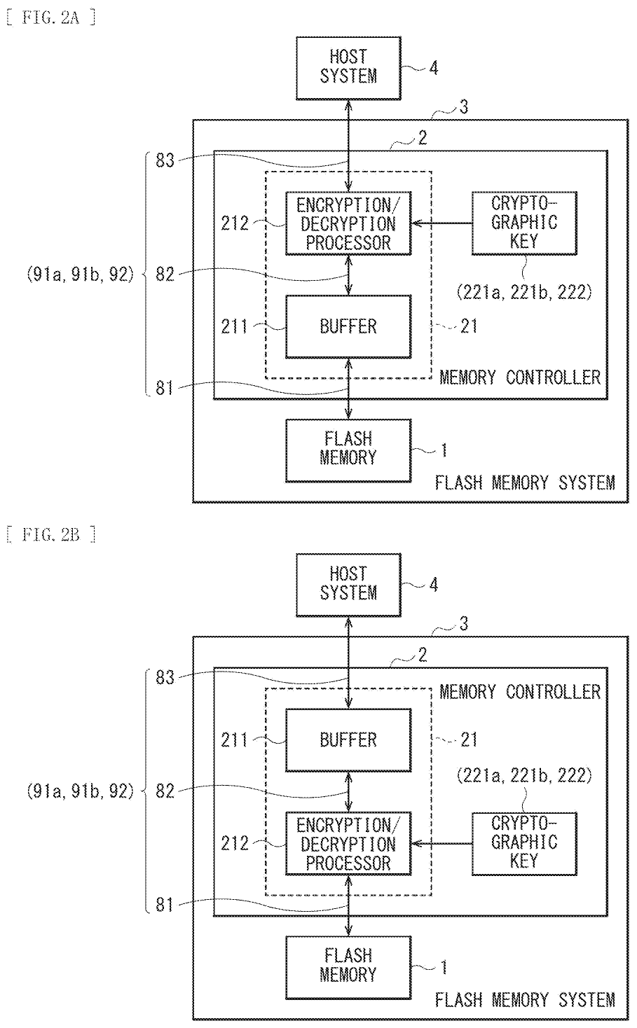

FIGS. 2A and 2B each illustrate a detailed configuration example of the arithmetic processor 21 in a block diagram.

As illustrated in FIGS. 2A and 2B, the arithmetic processor 21 includes a buffer 211 and an encryption/decryption processor 212. The buffer 211, the encryption/decryption processor 212, the host system 4, and the flash memory 1 are coupled to each other via various buses, i.e., internal buses 81 and 82 and an external bus 83, which are included in the buses 91a, 91b, and 92 described above. Specifically, as illustrated in FIGS. 2A and 2B, the internal bus 81 is coupled between the flash memory 1 and the arithmetic processor 21, and the internal bus 82 is coupled between the buffer 211 and the encryption/decryption processor 212 in the arithmetic processor 21. Further, the external bus 83 is coupled between the arithmetic processor 21 and the host system 4.

The buffer 211 is a part that temporarily accumulates data read from the flash memory 1 and data to be written into the flash memory 1. Specifically, data read from the flash memory 1 is held by the buffer 211 until the host system 4 is in a receivable state. Further, data to be written into the flash memory 1 is held by the buffer 211 until the flash memory 1 is in a writable state.

The encryption/decryption processor 212 performs an encryption process and a decryption process on data using any of the cryptographic keys 221a, 221b, and 222 described above, as illustrated in FIGS. 2A and 2B. Specifically, the encryption/decryption processor 212 performs the encryption process on data to be written into the flash memory 1, using any of the cryptographic keys 221a, 221b, and 222. Further, the encryption/decryption processor 212 performs the decryption process on data read from the flash memory 1 (any of the encrypted data 111a, 111b, and 112 described above), using any of the cryptographic keys 221a, 221b, and 222.

Details of the processes including the encryption process using any of the cryptographic keys 221a, 221b, and 222 will be described later.

In the example of FIG. 2A, the buffer 211 is disposed between the flash memory 1 and the encryption/decryption processor 212. Accordingly, in this example of FIG. 2A, data having undergone the encryption process (data before undergoing the decryption process) by the encryption/decryption processor 212, that is, each of the encrypted data 111a, 111b, and 112, is temporarily held in the buffer 211.

In contrast, in the example of FIG. 2B, the buffer 211 is disposed between the encryption/decryption processor 212 and the host system 4. Accordingly, in this example of FIG. 2B, data having undergone the decryption process (data before undergoing the encryption process) by the encryption/decryption processor 212 is temporarily held in the buffer 211.

In view of the above, comparing the configuration examples illustrated in FIGS. 2A and 2B with each other indicates that the configuration example of FIG. 2A in which data having undergone the encryption process (data before undergoing the decryption process) is held in the buffer 211 allows further improvement in security as compared with the configuration example of FIG. 2B.

### Operations, Workings, and Effects

### (A. Discarding of Data in Secure Region)

Typically, from the viewpoint of ensuring security, users may desire to discard data in a particular region (e.g., the foregoing secure region) in the flash memory when the flash memory system transitions to a power-off state (i.e., upon the power-off transition). Because various kinds of data to be secured are stored in the secure region as described above, users may desire to discard such data upon the power-off transition, rather than allowing it to remain thereafter.

Erasure of data from the flash memory is typically performed for one physical block at a time, as described above. Accordingly, in a case where, for example, data that may be left intact (that need not be discarded) upon the power-off transition and data that has to be discarded upon the power-off transition are both included in one physical block, handling of the data can be difficult.

To address such a case, a technique is conceivable as a comparative example in which data in the foregoing particular region such as the secure region is erased (or degraded) by, for example, causing a predetermined backup circuit to operate after the power-off transition (transition to the power-off state). However, such a technique of the comparative example involves a dedicated circuit, that is, the backup circuit described above or any other circuit for erasing or degrading data. Among such circuits, the backup circuit particularly becomes a burden in terms of cost and footprint.

Due to the need for the dedicated circuit as described above, it is thus considered to be difficult with the technique of the comparative example to improve security with a simple configuration.

### (B. Operation Example of Present Example Embodiment)

To cope with this, in the flash memory system 3 of the present example embodiment, the arithmetic processor 21 in the memory controller 2 performs the encryption process and the like using any of the cryptographic keys 221a, 221b, and 222 described above. A detailed description is given below of the encryption process and the like.

### (B-1. Encryption Process)

First, setting of whether or not it is necessary to discard data upon the power-off transition as described above, that is, setting of the normal region and the secure region described above, is performed in advance on the host system 4 side by the command Cm described above, for example. Specifically, in the example illustrated in FIG. 1, the LBA ranges 41a and 41b set on the host system 4 side define the normal regions, i.e., the regions requiring no discarding of data upon the power-off transition described above. Further, the LBA range 42 set on the host system 4 side defines the secure region, i.e., the region requiring discarding of data upon the power-off transition described above. The LBA range 42 set in this way is supplied from the arithmetic processor 21 to the management data region 12 in the flash memory 1 and stored in the management data region 12, as illustrated in FIG. 1, for example.

Thereafter, the arithmetic processor 21 (the encryption/decryption processor 212 described above) performs the encryption process with different techniques depending on whether or not it is necessary to discard data upon the power-off transition (the setting of the normal region and the secure region).

More specifically, first, on data included in the LBA ranges 41a and 41b (the normal regions), the arithmetic processor 21 performs the respective encryption processes using the fixed cryptographic keys 221a and 221b. Thereafter, the arithmetic processor 21 stores the encrypted data 111a and 111b resulting from such encryption processes in the user data region 11.

In contrast, on data included in the LBA range 42 (the secure region), the arithmetic processor 21 performs the encryption process using the cryptographic key 222 that is newly generated upon each power-on transition described above. Thereafter, the arithmetic processor 21 stores the encrypted data 112 resulting from such an encryption process in the user data region 11.

The encryption processes using the cryptographic keys 221a and 221b described above each correspond to a specific example of a “first encryption process” in one embodiment of the disclosure. The encryption process using the cryptographic key 222 described above corresponds to a specific example of a “second encryption process” in one embodiment of the disclosure.

The arithmetic processor 21 stores the cryptographic keys 221a and 221b for the foregoing normal regions in a nonvolatile region (for example, the foregoing management data region 12 in the flash memory 1) (see the broken-line arrows P1a and P1b in FIG. 1). In contrast, the arithmetic processor 21 stores the cryptographic key 222 for the foregoing secure region in a volatile region (for example, the foregoing volatile RAM 22 in the memory controller 2) each time the cryptographic key 222 is newly generated, unlike in the case with the cryptographic keys 221a and 221b for the normal regions. Note that in this case, the arithmetic processor 21 may store, for example, key information used to generate the cryptographic key 222 (information underlying the cryptographic key 222) in the volatile region, instead of the cryptographic key 222 itself.

In this connection, the encrypted data 112 corresponding to the foregoing secure region is erased at the following point in time, as with other data (user data): when all valid data become absent in a pertinent physical block; or immediately before newly writing data into the pertinent block. Further, it is considered to be unnecessary to distinguish between data not to be discarded upon the power-off transition described above (e.g., the encrypted data 111a and 111b) and data to be discarded upon the power-off transition (e.g., the encrypted data 112) in terms of, for example, address management method. In other words, these two kinds of data may be written in a mixed manner into the same physical block in the user data region 11.

### (B-2. Activation Processing)

In the present example embodiment, a processor such as the arithmetic processor 21 performs the following processing (activation processing), for example, upon the power-on transition (power activation) described above.

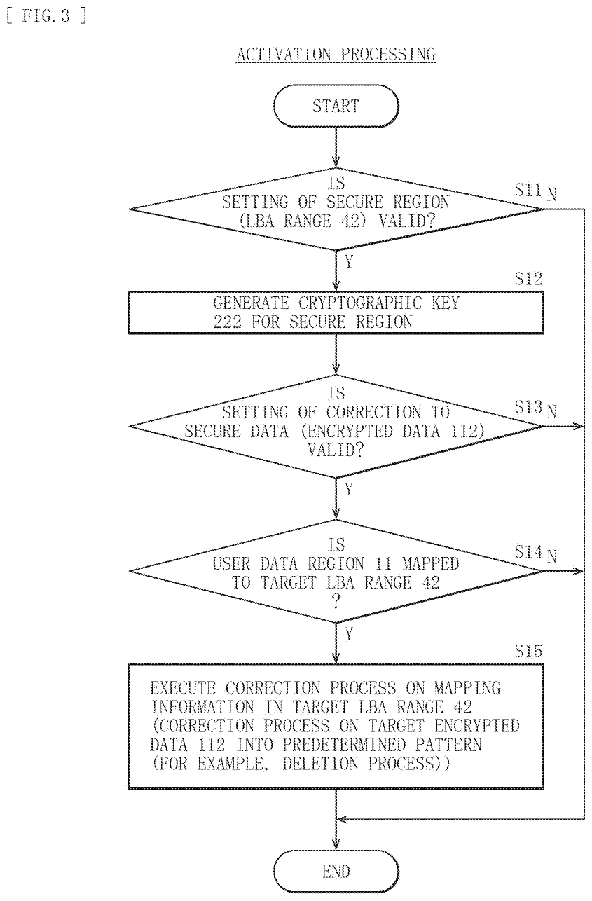

FIG. 3 illustrates an example of the activation processing according to the present example embodiment in a flowchart.

In the example of the activation processing illustrated in FIG. 3, the arithmetic processor 21 first determines whether the setting of the secure region (the LBA range 42) in the management data region 12 is valid or invalid in the foregoing command Cm supplied from the host system 4 (step S11). If the arithmetic processor 21 determines that the setting of the secure region is invalid (step S11: N), a series of processes illustrated in FIG. 3 (the activation processing) ends.

In contrast, if the arithmetic processor 21 determines that the setting of the secure region is valid (step S11: Y), the flow proceeds to a next step. That is, the cryptographic key 222 to be applied to the secure region is generated (step S12) on the basis of random numbers obtained from the random number generator 23, as described above. Thereafter, the arithmetic processor 21 determines whether setting of correction to secure data (the encrypted data 112) is valid or invalid in the management data region 12 (step S13). If the arithmetic processor 21 determines that the setting of the correction is invalid (step S13: N), the series of processes illustrated in FIG. 3 ends.

In contrast, if the arithmetic processor 21 determines that the setting of the correction is valid (step S13: Y), the flow proceeds to a next step. That is, the arithmetic processor 21 determines whether the user data region 11 is mapped to a target LBA range 42 (the LBA range 42 that is targeted for the correction) (step S14). If the arithmetic processor 21 determines that such mapping is not performed (step S14: N), the series of processes illustrated in FIG. 3 ends.

If the arithmetic processor 21 determines that such mapping is performed (step S14: Y), the flow proceeds to a next step. That is, the arithmetic processor 21 executes a correction process on mapping information in the target LBA range 42 (i.e., the LBA range 42 targeted for the correction). Specifically, the arithmetic processor 21 executes the correction process on the target encrypted data 112 (i.e., the encrypted data 112 targeted for the correction) into a predetermined pattern (step S15). As a result, already written data (the encrypted data 112) having undergone an update of its pattern is supplied to the host system 4 side. Accordingly, also in a case where it is desirable to set data to a predetermined pattern, as with data in a management region of a file system, for example, it is possible to update the encrypted data 112 into the predetermined pattern. As such a correction process on the encrypted data 112, for example, a deletion process may be executed on the encrypted data 112 as described in a parenthesis in FIG. 3.

The series of processes illustrated in FIG. 3 thus ends.

### (D. Workings and Effects)

According to the present example embodiment, in the manner described above, data included in the LBA ranges 41a and 41b (the normal regions) are subjected to the respective encryption processes using the fixed cryptographic keys 221a and 221b, and the resulting encrypted data 111a and 111b are stored in the user data region 11. In contrast, data included in the LBA range 42 (the secure region) is subjected to the encryption process using the cryptographic key 222 that is newly generated upon each power-on transition (power activation) described above, and the resulting encrypted data 112 is stored in the user data region 11.

As a result, after the power-off transition described above (for example, after power reactivation), any attempts to read data in the secure region results in failure to normally read the data because the cryptographic key 222 necessary for the decryption process is already lost. That is, because a new cryptographic key 222 is generated again upon the power reactivation (a second power-on transition), readable data turns into a random value. Further, the random number generator 23 used for generation of the cryptographic key 222, a circuit for performing the encryption process and the like using the cryptographic key 222, i.e., the encryption/decryption processor 212, and the like are also used for general security purposes. That is, existing circuits and the like are usable for such components. Accordingly, unlike in the foregoing comparative example, any dedicated circuit is substantially unnecessary. For these reasons, according to the present example embodiment, it is possible to improve security with a simple configuration.

Further, in the present example embodiment, the cryptographic keys 221a and 221b to be applied to data in the foregoing normal regions are stored in the nonvolatile region (e.g., the management data region 12 in the flash memory 1). In contrast, the cryptographic key 222 (or the key information used to generate the cryptographic key 222) to be applied to the foregoing secure region is stored in the volatile region (e.g., the volatile RAM 22 in the memory controller 2) each time the cryptographic key 222 (or the key information) is newly generated. As a result, data of the cryptographic key 222 or of the key information is discarded upon the power-off transition of the flash memory system 3 including the flash memory 1 and the memory controller 2, and is thus prevented from being reused, whereas data of the cryptographic keys 221a and 221b remain in the nonvolatile region, and are thus reusable later. For these reasons, according to the present example embodiment, it is also possible to improve convenience while further improving security.

Moreover, in the present example embodiment, the encrypted data 112 corresponding to the secure region is subjected to the correction process into the predetermined pattern (e.g., the foregoing deletion process) upon the power-on transition (power activation) described above. Accordingly, for example, in a case where it is desirable to set the encrypted data 112 to a predetermined pattern as described above, executing the above-described correction process makes it possible to appropriately cope with such a case. As a result, the present example embodiment makes it possible to improve convenience while ensuring security.

### 2. Modification Examples

Although the disclosure has been described above with reference to the example embodiment, the disclosure is not limited to such an example embodiment, and may be modified in a variety of ways.

For example, although the description has been given specifically of the respective configurations of the host system, the flash memory, the memory controller, and the arithmetic processor in the foregoing example embodiment, their respective configurations are not limited to those described in the foregoing example embodiment. Specifically, in the foregoing example embodiment, for example, the encrypted data 111a and 111b have been described as one example of the encrypted data corresponding to the foregoing normal region, and the encrypted data 112 has been described as one example of the encrypted data corresponding to the foregoing secure region. However, these examples are non-limiting, and the number, the kind, etc. of each of the encrypted data corresponding to the normal region and that corresponding to the secure region may be freely chosen. Further, although an example case where the random number generator 23 is provided in the memory controller 2 has been described in the foregoing example embodiment, this is non-limiting. For example, the random number generator 23 may be provided outside the memory controller 2. Moreover, although an example case where the flash memory 1 is a NAND flash memory has been described in the foregoing example embodiment, this is non-limiting. For example, a NOR flash memory may be used as the flash memory 1.

Further, although the description has been given specifically of the configuration (the generation method, the storage region, and the like) of each of the two kinds of cryptographic keys (the cryptographic keys 221a and 221b, and the cryptographic key 222) in the foregoing example embodiment, the generation method, the storage region, and the like of each of these cryptographic keys are not limited to those described in the foregoing example embodiment. Specifically, although an example case where the cryptographic keys 221a and 221b are each stored in the management data region 12 in the flash memory 1 as the nonvolatile region has been described in the foregoing example embodiment, this is non-limiting. That is, for example, the cryptographic keys 221a and 221b may each be stored in another nonvolatile region in the flash memory 1 or in the memory controller 2. Further, an example case where the encryption process and the decryption process are each performed using the cryptographic key has been described in the foregoing example embodiment. However, for example, a cryptographic key to be applied to the encryption process and a cryptographic key to be applied to the decryption process may be managed and used separately.

Moreover, although the description has been given specifically of the various process examples (the encryption process, the activation processing, the correction process, and the like described above) to be performed by the arithmetic processor 21 in the foregoing example embodiment, such various process examples described in the foregoing example embodiment are non-limiting. Specifically, in the foregoing example embodiment, for example, the deletion process on the encrypted data 112 has been described as one example of the correction process to be executed in the activation processing. However, such an example is non-limiting, and any different correction process may be executed.

Moreover, any two or more of the configuration examples, operation examples, and other examples described so far may be combined and applied in a desired manner.

Embodiments of the disclosure may be configured as follows.

(1)

A memory controller controlling a flash memory, the memory controller including
an arithmetic processor that performs control on data in a user data region of the flash memory, in which
the arithmetic processor
   performs a first encryption process on data included in a first region, using a first cryptographic key that is fixed, and stores first encrypted data resulting from the first encryption process in the user data region, and
   performs a second encryption process on data included in a second region, using a second cryptographic key that is newly generated upon each power-on transition during which power to the flash memory and the memory controller transitions from an OFF state to an ON state, and stores second encrypted data resulting from the second encryption process in the user data region.
      (2)

The memory controller according to (1), in which the arithmetic processor
stores the first cryptographic key in a nonvolatile region, and
stores the second cryptographic key or key information used to generate the second cryptographic key in a volatile region each time the second cryptographic key is newly generated.
   (3)

The memory controller according to (1) or (2), in which the arithmetic processor executes, on the second encrypted data, a correction process into a predetermined pattern upon the power-on transition.

(4)

The memory controller according to (3), in which the correction process includes a deletion process on the second encrypted data.

(5)

The memory controller according to any one of (1) to (4), in which
the first region includes a normal region that is set to require no discarding of data upon a power-off transition during which the power transitions from the ON state to the OFF state, and
the second region includes a secure region that is set to require discarding of data upon the power-off transition.
   (6)

A flash memory system including:
the memory controller according to any one of (1) to (5); and
the flash memory.

The memory controller and the flash memory system according to the respective embodiments of the disclosure each make it possible to improve security with a simple configuration.

1. A memory controller controlling a flash memory, the memory controller comprising
an arithmetic processor that performs control on data in a user data region of the flash memory, wherein
the arithmetic processor
performs a first encryption process on data included in a first region, using a first cryptographic key that is fixed, and stores first encrypted data resulting from the first encryption process in the user data region, and
performs a second encryption process on data included in a second region, using a second cryptographic key that is newly generated upon each power-on transition during which power to the flash memory and the memory controller transitions from an OFF state to an ON state, and stores second encrypted data resulting from the second encryption process in the user data region.

2. The memory controller according to claim 1, wherein the arithmetic processor stores the first cryptographic key in a nonvolatile region, and
stores the second cryptographic key or key information used to generate the second cryptographic key in a volatile region each time the second cryptographic key is newly generated.

3. The memory controller according to claim 1, wherein the arithmetic processor executes, on the second encrypted data, a correction process into a predetermined pattern upon the power-on transition.

4. The memory controller according to claim 3, wherein the correction process comprises a deletion process on the second encrypted data.

5. The memory controller according to claim 1, wherein
the first region comprises a normal region that is set to require no discarding of data upon a power-off transition during which the power transitions from the ON state to the OFF state, and
the second region comprises a secure region that is set to require discarding of data upon the power-off transition.

6. A flash memory system comprising:
the memory controller according to claim 1; and
the flash memory.
